(19) United States
(12) Patent Application Publication
(10) Pub. No.: US 2024/0253602 A1
(43) Pub. Date: Aug. 1, 2024

(54) WIRE ACTIVATED BRAKE SYSTEM FOR A WALKING AID

(71) Applicant: Topro Industri AS, Gjøvik (NO)

(72) Inventor: Jan Hallvard Myhren, Vingrom (NO)

(21) Appl. No.: 18/562,470

(22) PCT Filed: May 18, 2022
(86) PCT No.: PCT/NO2022/050112

§ 371 Date: Nov. 20, 2023

(30) Foreign Application Priority Data
May 21, 2021 (NO) 20210640

(51) Int. Cl. B60T 7/10; A61H 3/04

(52) U.S. Cl. CPC B60T 7/102; A61H 3/04; A61H 2003/046; A61H 2201/1635

(57) ABSTRACT

A wire activated brake system for a walking aid is provided, comprising wheels wherein the system comprises a pull system to activate the brakes, the pull system comprises, a housing and a brake lever and a brake wire wherein the brake wire exits the housing on the same side as the brake levers protrudes the housing. Furthermore, a brake actuator is provided, wherein the brake actuator comprises a deflection member, a wedge, a support member comprising a sliding surface, wherein the wedge is pretensioned in a position between the deflection member and the support member.

### FIELD OF INVENTION

This invention relates to support materials for elderly or disabled persons, more specifically to a brake system for a wheeled walking aid.

### BACKGROUND

A walking aid is a device for assisting a user while walking or engaging in exercise on various types of terrain, both inside and outside. A walking aid can be any type of device meant for aiding people with impaired ability to walk with wheels known as a rollator, roller trays or walkers.

The number and percentage of people using rollators and walking aids are increasing in most parts of the world, and the quality of life for these users depends on various support materials. Rollators are one of the most important ones and enables the users to remain independent and carry out everyday tasks like shopping and move around according to own free will.

Safe operation of a walking aid by a person with limited strength and limited control of movements is not a trivial issue. Loss of balance, sudden twitches, cramps and confusion may cause accidents. Different types of brake systems have been tried, among those are brake system with the wire from the brake lever protruding in an opposite direction from the brake lever house, than the brake lever.

For common rollators adapted for outdoor use, the handles are normally directed towards the user. This is beneficial for getting the handle tubes out of the way of the users' feet and knees. For these types of rollators, the brake wire is directed away from the user to not obstruct the use of the handles and brakes.

Documents US2013181489A1, EP2520266A1 and US2017174190A1 all disclose a rollator with the brake cables exits the brake handle housing on the opposing side relative to the brake levers. The downside of these rollators is that the load from the handles are acting downwards behind handle tubes, which may give an unsteady feel and unsteady balance. If the handle of the rollator is directed away from the user, the brake wire would protrude in the direction of the user, causing the problem of the wires interfering with the user.

Other common brake system, such as the one disclosed in CA2652195A1 teaches a solution where the brake cable is situated inside the handlebar at a right angle in relation to the brake lever. This has the downside that the cable or wire from the lever will need the system to handle the surplus wire if the rollator is height adjustable. Other known solutions where the wire or cable that runs in a right angle downwards from the brake lever and on the outside of any parts of the rollator has the downside that the cable or wire, which then must run inside a sleeve, will be bent with a small diameter bend if the rollator is lowered. This causes friction when the brake lever is pulls and the wire moves within the sleeve which in turn can impact brake adjustment setting and hence performance.

The invention described herein is an improvement on the braking system specially adapted to the needs of elderly and disabled people. In particular users who find themselves in a position where mobility, balance and muscle control slowly decrease and trembling and twitch increase, and are in need of a brakes that has sufficient brake force in relation to the force acting on the brake lever(s), while allowing gradual activation as opposed to binary on/off.

It is thus an aim of the present invention to provide a brake pull system where lever acts on wire not pinched in its sleeve at all heights of walking aid and to provide a brake actuator that provides increased braking force in relation to the displacement of the brake lever(s).

It is a further aim of the present invention to overcome the shortcomings of the prior art.

### SUMMARY OF THE INVENTION

The invention is set forth and characterized in the main claims, while the dependent claims describe other characteristics of the invention.

### BRIEF DESCRIPTION OF THE FIGURES

These and other characteristics of the invention will become clear from the following description of a preferential form of embodiment, given as non-restrictive examples, with reference to the attached schematic drawings.

FIG. 1 shows a walking aid

FIG. 2 shows parts of a handle and brake system

FIG. 3 shows a section view of the pull system

FIG. 4 shows a section view of the brake actuator

FIGS. 5a and 5b shows the brake actuator in two different positions

FIGS. 6a, 6b and 6c shows the brake lever in three different positions

FIGS. 7a and 7b shows the brake actuator two different positions

### DETAILED DESCRIPTION OF THE INVENTION

The following description will use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention i.e. it is with the respect to an unfolded upright walking aid in normal use on a floor. The terms are used for the reader's convenience only and shall not be limiting. Like numerals on different drawings describe the same feature. Numerals with apostrophe represents an additional feature represented by the same numeral, for instance the number 11 will represent one or the first of multiple or all of the multiples, and the numeral 11′

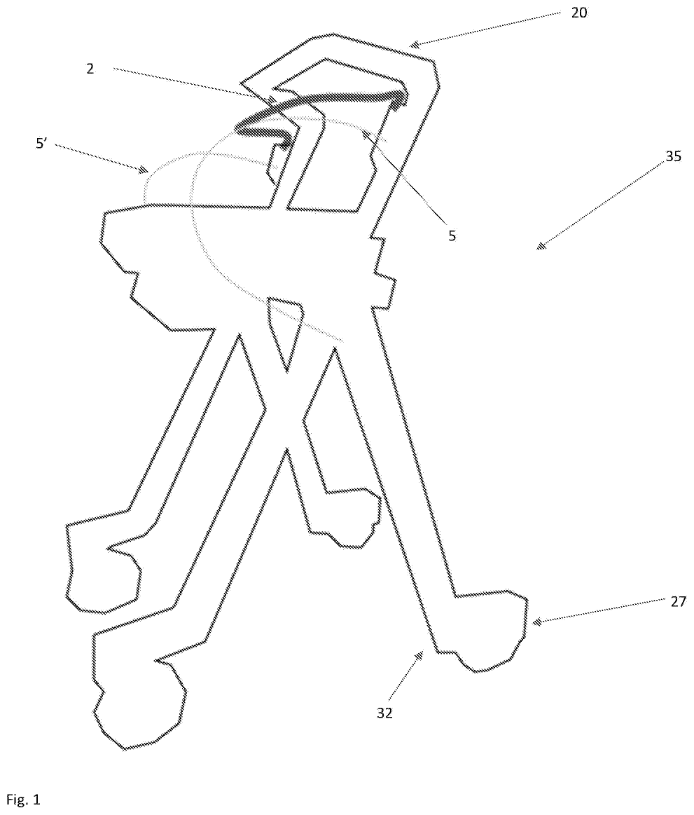

The frame of a wheeled walking aid like the one shown in FIG. 1 comprises left and right lower horizontal bar with wheels mounted near the ends and left and right upright bars. The upright bars are fitted with height adjusted handlebars. Normally, the height adjusted handlebars are fitted with a brake system. Furthermore, the walking aid may comprise a cross bar or foldable system connecting the two sides. The handlebar(s) may be two separate handles each with a brake lever (not shown) or a single across mounted rail 2, as illustrated in FIG. 1.

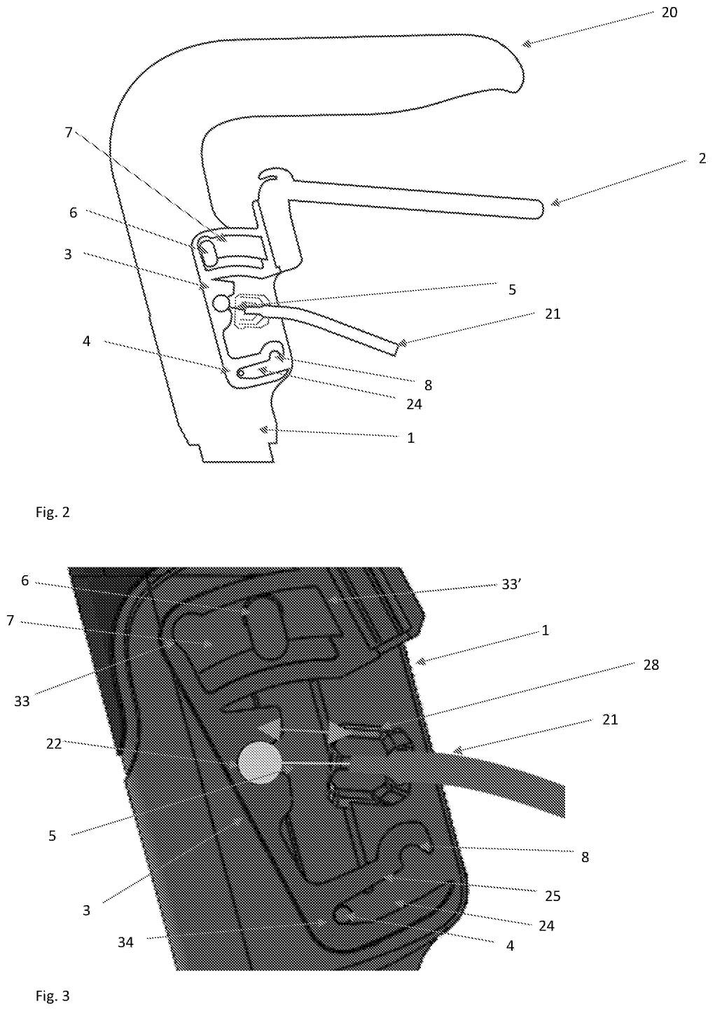

FIG. 2 illustrates the pull system that pulls on a wire 5 in relation to a sleeve to activate the brakes. The figure illustrates one side of the top of a handlebar 20 with a brake lever 2 positioned underneath the handlebar in reach of the user's hands. Below the handlebars 20 there is positioned a housing 1 to support and hold parts of the brake mechanism. The housing may be a structural part of the walking aid or a separate housing attached to, or close to, the handlebar(s) 20. The housing may also be a part of a support beam of the walking aid, and/or handle of the walking aid or parts thereof. In FIG. 1 both the brake lever 2 and the wire 5 surrounded by a sleeve 21 exits the housing 1 at the same side.

To achieve this, the brake lever 2 is connected to a brake rail latch 3 at least party situated inside the housing 1. The lever 2 is rigidly connected to brake rail latch 3 as to not allow relative movement between the two, so that a manipulation of the brake lever 2 manipulates the brake rail latch 3. The brake rail latch 3 may also be a structural part or extension of the brake lever 2.

FIG. 3 illustrates a section view section view of the brake rail latch 3 at least party situated inside the housing 1, wherein a connection portion, that connects to the brake lever 2, protrudes the housing 1. The brake rail latch 3 is hinged around a at least one pivot member 4. The pivot member 4 may be a bolt, pin, peg or the like in a suitable resilient material, such as metal, connected to the housing 1. The brake wire 5 is connected to the brake rail latch 3 at an anchor point 22 between where the pivot member 4 engages the brake rail latch 3 and the brake lever 2, such that a manipulation of the brake lever 2 rotates the brake rail latch 3 around the at least one pivot member 4 thereby causing a manipulation on the brake wire 5. The brake wire 5, 21 comprises a wire 5 inside a sleeve 21, wherein the sleeve 21 enclosed the wire 5 for at least a portion of the length of the wire 5. The wire 5 is anchored to the brake rail latch 3 and the sleeve 21 is anchored to an housing anchor point 28 in the housing 1 such that a displacement of the brake rail latch 3 displaces the wire 5 in relation to the sleeve 21. The term displaces should be understood as movement in a direction or a shift to another position, such that brake rail latch 3 rotates the wire 5 is pulled and thus moves. In FIG. 3 the invention is illustrated with an upwards pulling action, or upwards manipulation of the brake lever 2, whereby the brake rail latch 3 is rotated around pivot member 4, and since the anchoring point 22 for the wire is between the pivot point 4 and the lever 2, the wire 5 is pulled from its initial position, away from the exit point of the housing 1 where the brake wire 5 thus exits the housing 1 on the same side as the brake lever 2. This is especially convenient if a user operated the walking aid with the handle 20 pointing away from the user, since the protruding wire will not point towards the user and cause plunder and restrictions.

In FIGS. 2 and 3 the invention is illustrated with a second pivot member inside the housing 1. The second pivot member 6 may be a bolt, pin, peg or the like connected to the housing 1 in a resilient and tough material, such as metal. The brake rail latch 3 further comprises a first longitudinal shaped passage 7 adapted for receiving the second pivot member 6 both in a sliding manner and in a supporting stationary manner at the ends of the passage 7. When the brake rail latch 3 rotates about the first pivot member 4, the first longitudinal shaped passage 7 will act as a guide with stopper 33, 33's in each end to prevent the brake rail latch 3 from being rotated too far. In another embodiment the first longitudinal shaped passage 7 comprises only one stopper end 33 for the second pivot member 6 to pivot against and around. Furthermore, brake rail latch 3 comprises a second longitudinal shaped passage 24 adapted for receiving the first pivot member 4 in a sliding manner, and wherein the brake rail latch 3 further is hinged around the second pivot member 6. When the brake rail latch 3 rotates about the second pivot member 6, the second longitudinal shaped passage 24 will act as a guide with stopper and pivot point 34 in at least one end to prevent the brake rail latch 3 from being rotated too far. The brake wire 5 is connected to brake rail latch 3 between the points where the first and second pivot member 4, 5 engages the rail latch 3 i.e. between the first and second longitudinal shaped passages 7, 24. This allows a manipulation of the brake lever 2 in a first direction (downwards in FIG. 2) to rotate brake rail latch 3 around the first pivot member 4 thereby causing a manipulation on the brake wire 5 and further allows a manipulation of the brake lever 2 in a second direction opposite the first direction (upwards in FIG. 2), to rotate brake rail latch 3 around the second pivot member 6 thereby causing a manipulation on the brake wire 5.

Furthermore, the second longitudinal shaped passage 24 may be open in one end, such that it comprises a deflective member 25 comprising a notch 8 a distance from a first end of the second longitudinal shaped passage 24. Whereby the first pivot member 4 slides on the deflective member 25. When the handle is manipulated downwards, the brake rail latch 3 will rotate around the first pivot member 4 at the stopping end 43 of the first longitudinal shaped passage 7, and the second pivot member 6 will slide along the deflective member 25, deflecting the deflective member 25 a small portion, until the second pivot member 6 reaches the notch 8. Due to the deflection of the deflective member 25, the second pivot member 6 will stop in the notch 8, while the second pivot member also enters a slight recess in the first longitudinally shaped passage 7, whereupon the brake lever 2 is locked in place. This engages the “parking brake” function. To unlock the brake lever 2, an upwards force will deflect the deflective member 25 sufficient to release the second pivot member 6 from the notch 8, and the pretension in the brake rail latch 3 tensioning device 26 will restore the lever 2 to its normal operating position. The deflective member 25 may be comprised of a stiff but flexible material, thus deflective, such as plastic, composite or metal.

The brake wire 5, 21 is pretensioned with a tensioning member 26 thereby pretensioning the brake lever 2 in an initial position. The tension member 27 may be a spring situated around at least part of the wire 5. From the said initial position, when the brake lever 2 is raised toward the handle, it is adapted to engage a normal braking state position which will return to initial position when let go off. When the brake lever 2 is pushed downward away from the handle, is adapted to engage a parking-brake position. The tensioning member 26 may be connected to the brake wire 5, 21 at an opposite end from the anchoring point 22 of the brake rail latch 3 in connection with a brake actuator. In an non-illustrated alternative embodiment the tensioning member 26 may be positioned inside the housing 1, pretensioning the brake rail latch 3 away from the sleeve 21 and the direction the wire 5 and sleeve 21 exits the housing 1.

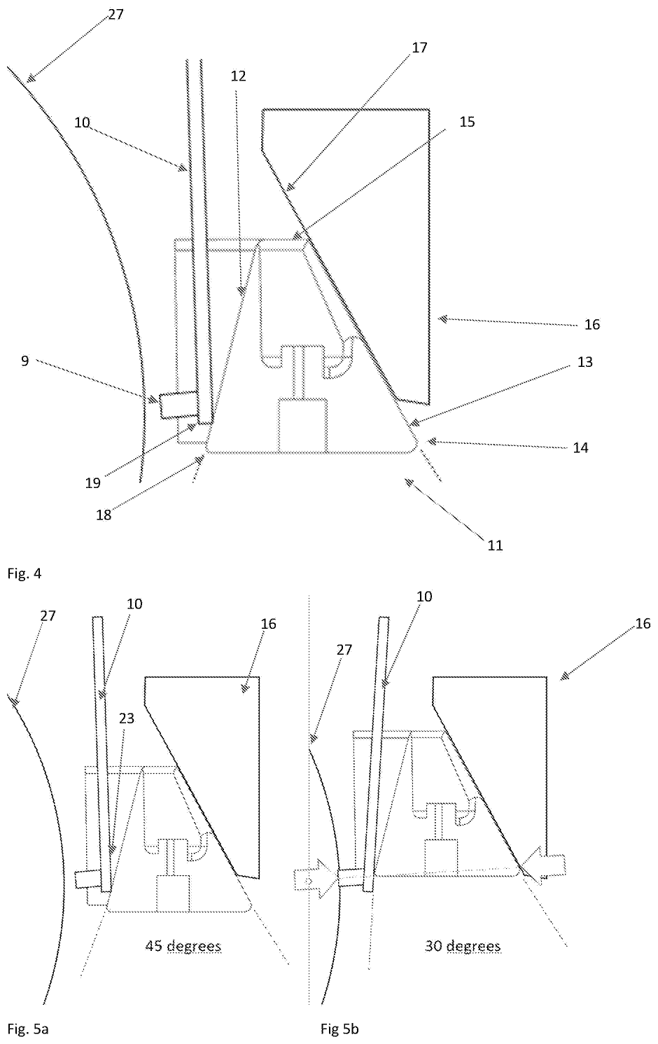

FIG. 4 illustrates the brake actuator of the wire activated brake system for a wheeled walking aid. The brake actuator comprises a brake deflection member 10 comprising a friction member 9. The brake actuator deflective member 10 may be comprised of a relative stiff but flexible material, thus deflective when extorted to a force, such as plastic, composite or metal. The friction member 9 may be any kind of brake pad commonly used. The friction member 9 may be an integral part of the deflective member 10 or it may be a releasable and attachable brake pad. The brake actuator further comprises a wedge 11 having two opposite faced sliding surfaces 12, 13, wherein the opposite faced sliding surfaces 12, 13 are inclined towards each other at the top of the wedge 11 to form a wedge shape, thereby comprising a wider section 14, or wider end portion, and a thinner section 15, or thinner end portion. The thinner section 14 being thinner than the wider section 14. The brake actuator further comprises a support member 16 comprising a sliding surface 17, wherein the wedge 11 is situated between the deflection member 10 and a portion of the support member 16. The first sliding surface 12 of the wedge is adapted to slide against a back part 23 of the deflection member 10. The back part 23 of the deflection member being the side opposite the side facing the wheel or tire 10, i.e. the side without the friction member 9. The second sliding surface 13 of the wedge is adapted to slide against the sliding surface 17 of the support member 16. A sliding surface is a relative flat and smooth surface where an object may slide unobtrusively.

The wedge 11 pretensioned in a position wherein at least a portion of the wider section 15 may or may not protrude an edge 19 of the deflection member 10 and the support member 16. Thus, the wedge is pretensioned in a position between the deflection member 10 and the support member 16, either entirely situated between the deflection member 10 and the support member 16, so that no part of the wedge 11 protrudes the edge 19 of the deflection member 10, or partly situated between the deflection member 10 and the support member 16, so that a at least a portion of the wider section 15 protrudes the edge 19 of the deflection member 10 and the support member 16. The wedge 11 is connected to a brake wire 5, at an anchor point 36, adapted to pull on the wedge 11 in the direction away from its pretensioned position, which is away from the wider portion 14 of the wedge 11. The wedge 11 is pretensioned by a tension member 26 situated between a wire connection point 36 that connects the wire 5 to the wedge 11 or parts of the wedge 11, and an anchoring point 31 of a sleeve 21 surrounding the wire for at least a distant of the length of the wire 5. The anchoring point 31 connects the sleeve 21 to the support member 26. The tension member 26, which is tensioned to exert a pretensioned force outward in a longitudinal directing, will thusly force the wedge 11 away from the anchoring point of a sleeve 21. When the wire is pulled, preferably by brake pull system as discloses, the wire 5 will displace the wedge 11 in a direction away from its pretensioned state, whereupon the wider section 14 forces the free end 19 of the deflection member 10 comprising the friction member 9 to be displaced in a direction towards a braking surface 27. The wedge 11 is displaceable by the wire 5 in a direction from the direction of the wire 5 and is displaceable away from the direction of the wire 5 by the tensioning member 26. by this the wedge 11 slidably fastened by the wire 5 between the sliding surface 17 of the support member 16 and the deflection member 10.

The deflection member 10 and its back part 23, the face facing away from the friction member 9 and brake surface 27, is a substantially longitudinal and flat member situated at an angle to the first sliding surface 12 of the wedge 11, and the second sliding surface 13 of the wedge is substantially parallel to the sliding surface 17 of the support member 16. Due to the wedge shape of the wedge 11, the angle to the deflection member 10 and the parallel to sliding surfaces 13, 17, a pulling force from the wire 5 will be translated to a pushing force on the free end of the deflection member 10 comprising the friction member 9, where the pulling force acting on the wire 5 is at an angle to the pushing force acting on the free end of the deflection member 10.

The deflection member 10 is comprised of a longitudinal flexible member in one end supported by the support member 16 or protruding from the support member 16 as a material integral part support member 16. The other end 19 is freely supported by the structural integrity of the deflection member 10 and is adapted to be deflected in a direction towards the braking surface 27. The friction member 9 is thus adapted to be displaced in a direction towards the braking surface 27 when the wedge 11 is displaced a distance from its pretensioned state or position. The wedge 11 may be pretensioned in different positioned, by altering the tensioning member 27 and the length of the wire 5. When the wedge 11 is pretensioned in a position where wider portion 14 protrudes the free end 19, as illustrated in FIG. 5a, an initial displacement of the wedge 11 from its pretensioned state will correspond to an equal ratio of displacement of the friction member 9 until the extremity edge 18 of the wedge 11 or the end of the wider portion 14 is displaced passed the edge 19 of the deflection member 10. Further displacement of the wedge 11 will correspond to a displacement the friction member 9 that is less than the displacement of the wedge 11. This resulting in a 1:1 ratio of displacement of the friction member 9 in relation to the displacement of the wedge 11 for a first distance of displacement of the wedge 11, and in a ratio of less than 1:1 of displacement of the friction member 9 in relation to the displacement of the wedge 11 for a second distance of displacement of the wedge 11. When the wedge 11 is pretensioned in a position where wider portion 14 does not protrudes the free end 19, as illustrated in FIG. 5b, the contribution of translating the movement and force from the wire 5 to the friction member 9 is mainly due to the angle of the two parallel sliding surfaces 17, 13 of the wedge 11 and support member 16. To achieve this the line created by the two slinging surfaces must be situated at an angle between the wire 5 and the direction of the contact point between the wedge 11 and the deflection member 10. If this angle is less than 45 degrees in relation the wire 5, the translating of the braking surface 9 will be less than the distance of the wire 5 when displaced. This gives a greater braking force from a longer distance traveled by the wire 5, which will provide an easier braking action for a user.

As seen in FIG. 5a, when the wedge 11 starts its movement upwards, the angled gliding surfaces 12, 13 of the wedge both facilitates in the transmission of movement, giving here as a non-limiting example, of 45 degree angle between the wedge 11 movement direction and the friction member 9. This gives an approximate 1:1 transmission of movement. In FIG. 5b, wherein end 19 of the deflection member is above the corner 18 of the wider section 14 of the wedge 11, the angle difference is reduced to 30 degrees, creating 1:1,7 gearing, enabling the user to apply a higher braking force on the tire with a minimum of input force. It should be understood that angle between the wedge 11 movement direction and the friction member 9 may be anywhere between 0-90 degrees. At this point the wedge 11 provides line contact with the friction member 9 and opposite side of the support member, providing sturdy force transfer with low deflection. The braking surface 27 is in the figure the outer part of the wheel of the walking aid, but it should be understood than the braking surface 27 may be any part of a tire, a wheel, or parts thereof that would allow the wheel to stop.

The support member 16 may be comprised of a rigid housing or shell surrounding at least parts of the brake actuator, and whereby the support member 16 is situated in proximity to a wheel and/or parts of an support beam connected to a wheel of the walking aid, and wherein the rigid support member 16 and the wedge 11 are of a non-compressible material. The support member 16 may be an structural part of any part of the walking aid that is connected to a wheel, or it may be a separate part connected to or in any part of the walking aid that is connected to a wheel.

In FIGS. 6a, 6b and 6c the pull system is illustrated in three different states of use. Wherein the FIG. 6a illustrates the brake lever 2 in its initial state where the brake lever 2 may be manipulated by a user to any on of the two other states. In this initial state the tensioning member 26 (not shown) externs a force on the anchor point 22 of the wire to the brake rail latch 3 forcing the brake rail latch 3 towards the anchor point 28 of the sleeves 21. The first longitudinal shaped passage 7, which may be a cut out portion of the brake rail latch 3, is supported in one end by contact with the second pivot member 7. The second longitudinal shaped passage 7, which in this illustration a cut out portion of the brake rail latch 3 with an open end, is supported in the closed end by contact with the first pivot member 4. In this state the distance between the anchor point 22 of the wire and the anchor point 28 of the sleeves 21 to the housing 1. his state of the pull system corresponds to the state of the brake actuator illustrated in FIG. 5a, wherein the brakes are not activated.

FIG. 6b illustrates a state wherein a user has manipulated the brake lever in the upwards directing indicate by the arrow. In this state the brake system is free du be modulated by a user, wherein a small displacement of the brake lever from initial position corresponds to a small braking force applied by the brake actuator, and wherein a further and larger displacement of the brake lever corresponds to a greater braking force applied by the brake actuator. In this initial state the forces from the tensioning member 26 (not shown) is overcome by the forces applied by the user to the brake lever 2, wherein the anchor point 22 of the wire 5 exerts a force on the wire 5 and forcibly pulls the wire 5 away from the anchor point 28 of the sleeves 21. This in turn will pull the other end of the wire 5 attached to the wedge 11 towards the other end of the sleeve, thereby displacing the wedge 11. The first longitudinal shaped passage 7 has moved in relation to the second pivot member 6, and the second pivot member 6 no longer rest on and end of the second longitudinal shaped passage 24. This relative displacement between the second pivot member 6 the second longitudinal shaped passage 7 is due to the force from the brake lever 2, that causes an rotation of the brake rail latch 3 which is supported in the closed end by at the first pivot member 4. If a user stops manipulating the brake handle 2, the tensioning member 26 will force the brake lever 2 to its initial state.

FIG. 6c illustrates a state wherein a user has manipulated the brake lever 2 in the downwards directing indicated by the arrow. In this state the “parking brake” function is activated and the forces needed to dislodge the first pivot member 4 from the notch 8 is greater that the forces applied by the tensioning member 5, and the braking system is locked in place. The second longitudinal shaped passage 24 is here illustrated with an open end in one end, such that the longitudinal shaped passage 24 is enclosed a deflective member 25 comprising the notch 8 a distance from a first closed end of the second longitudinal shaped passage 24 adapted to receive and support the first pivot member 4 when the brake rail latch 3 is rotated around it. The first pivot member 4 has moved from its initial position from the closed end along the deflective member 25 as the brake rail latch 3 has been rotated about the second pivot point. The handle when manipulated downwards, rotates the brake rail latch 3 around the first pivot member 4 at a stopping end of the first longitudinal shaped passage 7, and the second pivot member 6 slides or moves along the deflective member 25, deflecting the deflective member 25 a sufficient portion, until the second pivot member 6 reaches the notch 8. Due to the deflection of the deflective member 25, the second pivot member 6 will be held in place in the notch 8, as the deflecting member 25 pushes on the first pivot member 4, whereupon the brake lever 2 is locked in place. To unlock the brake lever 2, a user must exert a upwards force on the brake lever 2 to deflect the deflective member 25 sufficient to release the second pivot member 6 from the notch 8, and the pretension in the brake rail latch 3 from the brake wire 5 and sleeve 21 will restore the lever 2 to its initial state. The deflective member 25 may be comprised of a stiff but flexible material, thus deflective, such as plastic, composite or metal.

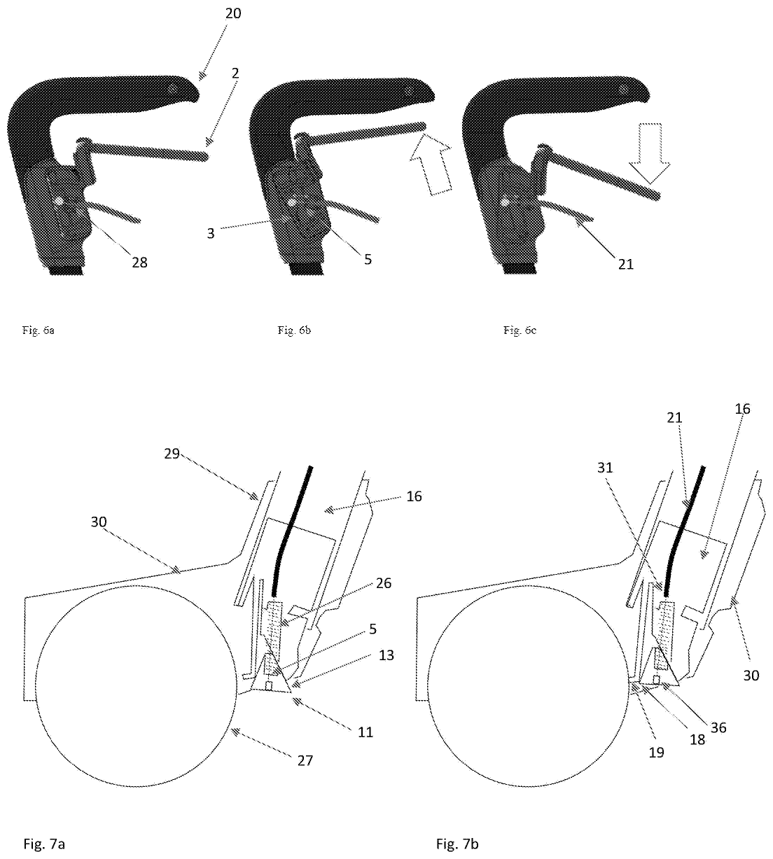

FIGS. 7a and 7b illustrates the brake actuator of the invention positioned in the lower part of the support beams of a walking aid that supports the wheels 27, wherein FIG. 7a illustrates the brake actuator in an initial state wherein the brakes are not engages. This state corresponds to the brake handle 2 being in its initial state. FIG. 7b illustrates the brake actuator in an engaged state. The engaged state corresponds the brake lever 2 being ether manipulated in an upwards or downwards direction from its initial state. In FIG. 7a the wedge 11 is in its pretensioned positioned a distance from the anchor point 31 of the sleeves to the support member 16. The deflection member is situated at a distance away from the surface of the wheel 27, and the wheel is free to rotate. In FIG. 7b the wedge 11 moved in relation to its pretensioned positioned a distance towards the anchor point 31 of the sleeves to the support member 16, by the pull of the wire 5. The end 19 of the deflection member 10 is now engaged in surface of the wheel 27, and the wheel is not free to rotate. As the wider portion of the wedge 11 is forced between the gliding surcease 17 of the support member 16 and the support member 16, the ende19 of the deflection member 10 is displaced towards the surface of the wheel due to the widening of the wedge 11 and the fact that gliding surcease 17 of the support member 16 is stationary and does not deflect or move, which forces the ende19 of the deflection member 10 to be moved. The deflection member 10 is preferably pretensioned in the state illustrated in FIG. 7a, where the end19 is free from the wheel 27. This will cause the deflection member 10 to return to its initial state when the brakes are not engaged so the friction member 9 is not touching, interfering or rubs against the 27 wheels when not activated.

In FIGS. 7a and 7b the support member 16 is illustrated as a housing inside the support beam 29 and held in place with a fastening member. The support member 16 is illustrated with a main portion from which both the support portion, comprising the sliding surface 17, and the deflection member 10, protrudes. The wire 5 with the sleeve 21 goes through the main portion of the support member 16, where in sleeve is anchored in an anchor point 28 to the support portion. The tensioning member 26 is supported in one end by the main portion of the support member 16 and in another end by the wedge 11, to pretension the wedge 11 away from the anchor point 28 of the sleeve 21. The housing 1, deflection member 10, support member 16 and deflection member 25 may preferably be comprised a resilient and tough material, such as metals like steel, aluminum or titanium, or other material such as polymer, polymer composites, composites, plastic, thermoplastic or plastic composite.

The invention disclosed herein relates to a wire activated brake system for a rollator comprising a pull system, disclosed herein, to be operate by a user, where the modulation of the pull system modulates the brake actuator disclosed herein, through the shared wire 5.

Although specific embodiments of the invention have been described and illustrated herein, it is recognized that modifications and variations may readily occur to those skilled in the art, and consequently, it is intended that the claims be interpreted to cover such modifications and equivalents.

### REFERENCE NUMERALS

1 Housing
2 brake lever
3 Brake rail latch
4 Pivot member, first pivot member
5, 5′ Wire
6 Second pivot member
7 First longitudinal shaped passage
8 Notch in brake rail latch 8
9 Friction member, brake pad
10 Deflection member of the brake actuator
11 Wedge
12 First sliding surface of wedge
13 Second sliding surface of wedge
14 Wider end of wedge
15 Thinner end of wedge
16 Support member, brake actuator housing
17 Sliding surface of support member
18 Corner edge of wedge
19 Free end of deflection member
20 Handle or handlebar
21 Sleeve enclosing wire
22 Anchor point for wire to brake rail latch
23 Back part of deflection member
24 Second longitudinal shaped passage
25 Deflective member of the brake rail latch
26 Tensioning member
27 Tire, wheel, brake surface
28 Anchor point for sleeve to housing
29 support beam of walking aid
30 Casing connecting wheel and beam
31 Anchor point of sleeve to support member
32 Brake actuator
33, 33′ Stopper ends of first passage
34 Stopper end of second passage
35 Walking aid
36 Anchoring point of wire to wedge

1. A wire activated brake system for a walking aid comprising wheels, the wire activated brake system comprising a pull system to activate the brakes, the pull system comprising:
a housing, and:
a brake lever connected to a brake rail latch, wherein the brake rail latch is situated at least partly inside the housing and wherein the brake rail latch is hinged around at least one pivot member connected to the housing, and;
a brake wire connected to the brake rail latch at an anchor point between the at least one pivot member and the brake lever, such that a manipulation of the brake lever rotates the brake rail latch around the at least one pivot member thereby causing a manipulation on the brake wire,
wherein the brake wire exits the housing on the same side as the brake levers protrudes the housing.

2. The wire activated brake system according to claim 1, wherein the pull system comprises a second pivot member inside the housing, and the brake rail latch further comprises a first longitudinal shaped passage adapted for receiving the second pivot member in a sliding manner, and a second longitudinal shaped passage adapted for receiving a first pivot member in a sliding manner, and wherein the brake rail latch further is hinged around a second pivot member and wherein the brake wire is connected to the brake rail latch between the first and second pivot members thereby allowing a manipulation of the brake lever in a first direction to rotate the brake rail latch around the first pivot member thereby causing a manipulation on the brake wire and allowing a manipulation of the brake lever in a second direction opposite the first direction, to rotate the brake rail latch around the second pivot member thereby causing a manipulation on the brake wire.

3. The wire activated brake system according to claim 2, wherein the second longitudinal shaped passage comprises a deflective member comprising a notch in the brake rail latch whereby the first pivot member slides on the deflective member and is arranged to stop in the notch when the brake lever is manipulated in the second direction, whereupon the brake lever is lockable in place when the first pivot member is situated in the notch.

4. The wire activated brake system according to claim 1, wherein the brake wire is pretensioned with a tensioning member thereby pretensioning the brake lever in a first position.

5. The wire activated brake system according to claim 1, wherein the brake wire comprises a wire inside a sleeve for at least a portion of a length of the wire, wherein the wire is anchored to the brake rail latch and the sleeve is anchored to the housing such that a displacement of the brake rail latch displaces the wire in relation to the sleeve.

6. The wire activated brake system according to claim 1, wherein the tensioning member is connected to the brake wire at an opposite end from an anchoring point of the brake rail latch in connection with a brake actuator.

7. The wire activated brake system according to claim 1, wherein the housing forms part of a support beam of the walking aid, and/or a handle of the walking aid or parts thereof.

8. A wire activated brake system for a rollator comprising a brake actuator, the brake actuator comprising
a deflection member comprising a friction member, and;
a wedge having a two opposite faced sliding surfaces, wherein the opposite faced sliding surfaces have an inclination towards each other to form a wedge shape, thereby comprising a wider section and a thinner section, and;
a support member comprising a sliding surface, wherein the wedge is situated between the deflection member and the support member, and the first sliding surface of the wedge is adapted to slide against a back part of the deflection member and wherein second sliding surface of the wedge is adapted to slide against the sliding surface of the support member,
wherein the wedge is pretensioned in a position between the deflection member and the support member, and wherein the wedge is connected to a brake wire adapted to displace the wedge in a direction away from the pretensioned state of the wedge, whereupon the wider section forces a free end of the deflection member comprising the friction member in a direction towards a braking surface when the wedge is forcibly displaced by force from the brake wire.

9. The wire activated brake system according to claim 8, wherein the deflection member comprises a longitudinal flexible member in one end supported by the support member and another end adapted to be deflected in a direction towards the braking surface, wherein the deflection member and said back part is situated at an angle to the first sliding surface of the wedge and wherein the second sliding surface of the wedge is substantially parallel to the sliding surface of the support member.

10. The wire activated brake system according to claim 8, wherein the deflection member comprises a protruding part protruding from the support member, wherein the protruding part comprises an end adapted to be deflected in a direction towards the braking surface, wherein the deflection member and said back part is situated at an angle to the first sliding surface of the wedge and wherein the second sliding surface of the wedge is substantially parallel to the sliding surface of the support member.

11. The wire activated brake system according to claim 8, wherein the friction member is adapted to be displaced in a direction towards the braking surface, wherein at least a portion of the wider section or an extremity edge of the wedge protrudes an end of the deflection member, whereby the wedge is displaced a distance from the pretensioned state of the wedge, wherein the displacement of the wedge from the pretensioned state will correspond to an first ratio of displacement of the friction member for a first distance of displacement of the wedge until an extremity edge of the wedge is displaced past the edge of the deflection member, whereby further displacement of the wedge will correspond to a displacement the friction member that is less than the first ratio of displacement, thereby resulting in a first ratio of displacement of the friction member in relation to the displacement of the wedge for a first distance of displacement of the wedge, and in a second ration of displacement that is less than the first ratio of displacement of the friction member in relation to the displacement of the wedge for a second distance of displacement of the wedge.

12. The wire activated brake system according to claim 11, wherein the wedge is displaceable by the wire in a direction to and from the direction of the wire and slidably fastened by the wire between the sliding surface of the support member and the deflection member.

13. The wire activated brake system according to claim 8, wherein the wedge is pretensioned by a tension member situated between a the wire and an anchoring point of a sleeve surrounding the wire for at least a distance of the length of the wire.

14. The wire activated brake system according to claim 13, wherein the tension member is a spring situated around at least part of the wire.

15. The wire activated brake system according to claim 8, wherein the friction member is a brake pad and wherein the braking surface is a tire, a wheel, or parts thereof.

16. The wire activated brake system according to claim 8, wherein the support member comprises a rigid housing or a shell surrounding at least parts of the brake actuator, and whereby the support member is situated in proximity to a wheel and/or parts of an support beam connected to a wheel of the walking aid, and wherein the rigid support member, the wedge and the deflection member are non-compressible.

17. A wire activated brake system for a rollator comprising a pull system in accordance with claim 1, and a brake actuator comprising
a deflection member comprising a friction member, and;
a wedge having a two opposite faced sliding surfaces, wherein the opposite faced sliding surfaces have an inclination towards each other to form a wedge shape, thereby comprising a wider section and a thinner section, and;
a support member comprising a sliding surface, wherein the wedge is situated between the deflection member and the support member, and the first sliding surface of the wedge is adapted to slide against a back part of the deflection member and wherein second sliding surface of the wedge is adapted to slide against the sliding surface of the support member,
wherein the wedge is pretensioned in a position between the deflection member and the support member, and wherein the wedge is connected to a brake wire adapted to displace the wedge in a direction away from the pretensioned state of the wedge, whereupon the wider section forces a free end of the deflection member comprising the friction member in a direction towards a braking surface when the wedge is forcibly displaced by force from the brake wire.
